(19) United States
(12) Patent Application Publication
(10) Pub. No.: US 2009/0199131 A1
(43) Pub. Date: Aug. 6, 2009

(54) INTERACTIVE DATABASE FOR CREATION AND CUSTOMIZATION OF FORMS

(76) Inventor: Linda KAGAN, New York, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/366,761

(22) Filed: Feb. 6, 2009

Related U.S. Application Data
(60) Provisional application No. 61/026,515, filed on Feb. 6, 2008.

(51) Int. Cl. G06F 3/048; G06F 17/30

(52) U.S. Cl. 715/810; 707/100; 707/E17.044

(57) ABSTRACT

A process for interactively providing forms to a user is provided. The process begins by storing a plurality of forms in a user accessible database, where each form is identifiable based on its content. Then a user chooses between a multiple organizational structures and selects at least one form to use. The form is then adapted based on already inputted personal information about the user and finally the form is exported as a PDF to a hard drive, portable digital device or printer.

### RELATED APPLICATIONS

This application claims priority to Provisional Application Ser. No. 61/026,515 filed on Feb. 6, 2008 and incorporated herein by reference in its entirety.

### FIELD OF THE INVENTION

The present invention relates to a process for providing forms from a database to a user and allowing the user to customize and print the appropriate form.

### BACKGROUND OF THE INVENTION

In many circumstances it is necessary for children to travel without their parents. At the same time, travel authorities (e.g. airlines, airports, railroads, bus companies, etc.), hospitals, schools and other entities have become more dependent on authorization forms regarding minors. In many jurisdictions minors require the consent of a parent or guardian to receive medical care or to be transported by someone other than a parent. The problem of not having the necessary forms is most prevalent for parents who are away from their children for extended periods of time or for children traveling without parental supervision.

It is a burdensome task to locate the necessary forms, discern which particular forms are necessary for a particular circumstance and to then complete these forms. Travel companies, hospitals and schools have other priorities and are often unhelpful to parents in preparing the necessary paperwork.

### SUMMARY OF THE INVENTION

The invention provides a process for displaying and providing the forms necessary for children when their parents are not present. These forms may include but are not limited to: temporary guardian forms, medical consent forms, school trip permission forms or domestic/international travel authorization forms.

In addition, the invention stores personal information about a user necessary to properly fill out the forms. The personal information only needs to be entered once after which it can be automatically added to any form.

It is a burdensome task to determine which forms are necessary and then to prepare them with all the relevant information. The present invention enables users to select forms and prepare them in a significantly improved manner.

A plurality of forms are stored in a database. The forms are organized by category and by package. The user chooses whether to find a form(s) by category or by package. The user also has the option of viewing all of the forms or to request a custom form.

After choosing an organizational structure, the user must choose which form(s) to purchase. Once the forms are selected, access to those forms must be allowed. This will normally occur upon confirmation that payment has been made.

Next the process will complete the forms with the personal information previously entered by the user, including the addition of a picture uploaded by the user. Though this step can occur any time after the personal information has been inputted by the user.

And finally, the form is printed out for safe keeping or travel.

### BRIEF DESCRIPTION OF THE FIGURES

To further satisfy the recited objectives, a detailed description of typical embodiments of the invention is provided with reference to appended drawings that are not intended to limit the scope of the invention, in which:

FIG. 1 is a flow chart of the first embodiment of the present invention; and

FIG. 2 is a flow chart of the second embodiment of the present invention.

### DESCRIPTION OF THE INVENTION

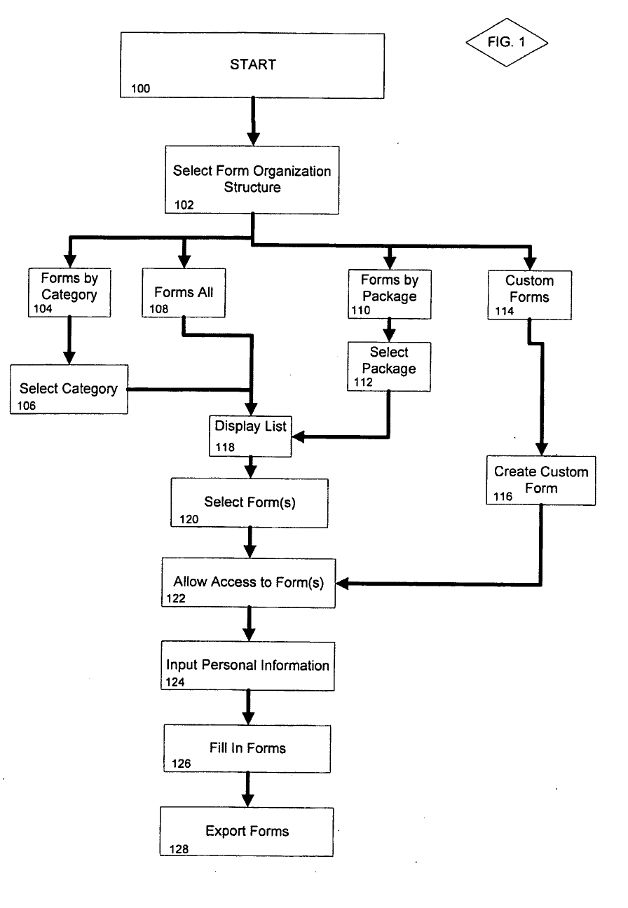

A plurality of forms are stored in a user accessible database, retrievable in four different structures—forms by category, forms all, forms packages and custom forms. In addition to storing the forms themselves, the database contains content identifiers, which associate the forms with particular categories or packages. FIG. 1 describes a first embodiment of the present invention. In the first embodiment, step 100 (start) begins the process. Step 100 (start) is followed by step 102 (selecting form organization structure). Depending on which structure is chosen, the process moves to one of steps 104 (forms by category), step 108 (all forms), step 110 (forms by packages) or step 114 (custom forms).

In step 104 (forms by category) a list of multiple categories is displayed. This list may include the categories of: Child Travel Forms, Traveling Parents: Children's Authorization Forms, Babysitter Authorization Forms, Americans Living Abroad: Children's Travel Forms, and others. Next at step 106 (select category), one of the displayed categories is selected and at step 118 a list of available forms is displayed.

If “all forms” is chosen from the organization selection at step 102, the process proceeds to step. 108 (all forms) and a list of all available forms which satisfy the selected criteria is displayed at step 118 (display list), whereby any form or multiple forms can be selected from the list.

If “forms by packages” is chosen from the organization selection at step 102, the process proceeds to step 110 (forms by package). When “forms by package” is selected, a list of multiple packages is displayed. These packages are defined as a group of forms that are commonly needed in conjunction with each other. Possible packages include: Traveling Parents Package, Babysitter Care Package, Children Traveling Alone to International Destinations, American Citizens Living Abroad with Children Traveling Alone Package, and others. Once the available packages are displayed at step 110 (forms by package), one or more packages are selected at step 112 (select package). From step 112 (select package), the process proceeds to display the list of forms related to the selected package(s) at step 118.

When “custom forms” is selected at step 102, a window appears which allows the input of a request for a specially designed form. The specially designed form is then created at step 116 and the process proceeds directly to step 122 (allow access to form) to determine if access to the form is allowed.

At step 118 (display list), a list of relevant forms is displayed. This list may provide a name, a brief description of each form and a price. One or multiple forms are then selected at step 120 (select form).

Once the form or forms have been selected or created, the process proceeds to step 122 (allow access to form) to determine if access to the forms is allowed. Prior to access being allowed, the user will be able to previews the form, but it will be displayed with a watermark and they will not be able to save it, print it or copy from it. Access may be restricted to administrative personnel or users who have purchased the particular forms. Certain forms may be provided free of charge, in which case access is always allowed.

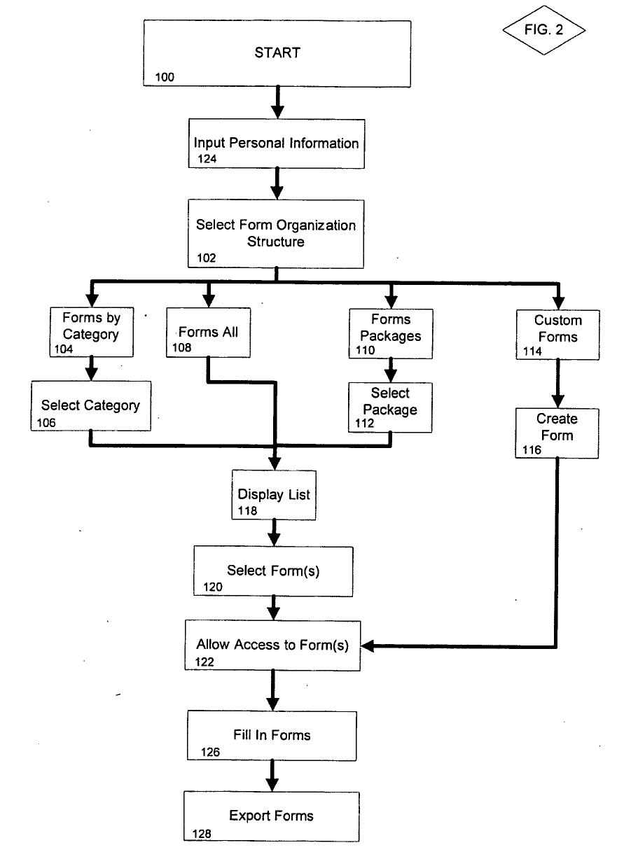

A further element of the present invention is to allow a user to input personal information so that the information can be added to multiple forms automatically. In the first embodiment, step 124 (input personal information) is performed after access to the form has been allowed. In a second embodiment, described in FIG. 2, the personal information is inputted first, before step 102 (select form organization structure). The precise timing of step 124 (input personal information) can also be anywhere between step 100 (start) and step 126 (fill in forms).

There is a multitude of personal information, also referred to as personal characteristics, that may be entered. Some examples include: dates of travel, destination of travel, home location, marital status of parents, name of guardian, relationship to child, telephone numbers, addresses, email addresses, dates of birth, age, drug allergies, food allergies, medical conditions, blood type, other conditions/sensitivities, passport number, and passport expiration date.

Included in the overall step of inputting personal information are the sub-steps of selecting a family structure and selecting a state. Preferably, the possible choices for both of these sub-steps are displayed for the user. In the case of selecting a family structure, three structures are displayed—single parent, parents living together and parents living apart. Each different structure is identified both by the words and by a descriptive picture. The state selection sub-step is preferably performed by a scroll down menu.

In addition, the process allows a user to upload a picture and for the picture to be included on the form.

After step 126 (fill in forms), the forms are exported to a physical medium such. This occurs in step 128 (export forms). The exporting which takes place in step 128 (export forms) preferably involves sending a signal to a printer (not shown) which prints the forms on paper. Though, step 128 (export forms) may also involve other methods of exporting the forms, including as examples: transferring a data file containing the forms to a portable electronic device capable of displaying the forms, saving the files in memory of a computer for later retrieval by creating a link for a user to download the form as a PDF file to their personal computer.

The present invention may be embodied in other specific forms without departing from its spirit or essential characteristics. The described embodiments are to be considered in all respects only as illustrative and not as restrictive.

1. A process for interactively providing forms to a user comprising the steps of:
storing a plurality of forms in a user accessible database, the plurality of forms each having at least one content identifier;
selecting between a plurality of organizational options, which identify specific forms of the plurality of forms based on the content identifier;
selecting at least one form of the plurality of forms;
adapting the at least one form to correspond with the personal characteristics of an individual;
exporting the at least one form to a physical medium.

2. The process of interactively providing forms to a user of claim 1 wherein the plurality of organizational options are designed to assist in locating the necessary forms for a given situation.

3. The process of interactively providing forms to a user of claim 1 wherein, the plurality of forms are relevant to a child traveling without a parent or a parent traveling without his or her child.

4. The process of interactively providing forms to a user of claim 1 wherein access to the at least one form is withheld until approval is granted.

5. The process of interactively providing forms to a user of claim 1 wherein the physical medium is paper.

6. The process of interactively providing forms to a user of claim 1 wherein the physical medium is a hard drive.

7. The process of interactively providing forms to a user of claim 1 wherein the physical medium is a portable digital device capable of displaying the forms.

8. The process of interactively providing forms to a user of claim 1 wherein the personal characteristics are family structure, state of domicile/residence, medical information, insurance information and/or travel information.

9. The process of interactively providing forms to a user of claim 1 further comprising the step of inputting the personal characteristics of an individual.

10. The process of interactively providing forms to a user of claim 9 wherein the inputting of the personal characteristics of an individual includes uploading a picture such that the picture can be incorporated into the forms.

11. The process of interactively providing forms to a user of claim 7 wherein the step of inputting the personal characteristics of an individual is performed prior to the step of selecting between a plurality of organization options.

12. The process of interactively providing forms to a user of claim 1 wherein the personal characteristics of an individual are acquired from multiple sources and integrated into a single file.

13. The process of interactively providing forms to a user of claim 1 wherein the organizational options are at least: Forms by Category, Forms All, Forms Packages and Custom Forms.

14. The process of interactively providing forms to a user of claim 10 wherein the organizational option of Forms by Category includes at least one of the categories of: Child Travel Forms, Traveling Parents: Children's Authorization Forms, Babysitter Authorization Forms or American's Living Abroad: Children's Travel Forms.

15. An apparatus for providing forms to a user comprising:
an input module for inputting personal information;
a database module for storing forms, the forms being classified by category and by package;
a physical display for displaying the forms;
an access module for allowing access to the forms; and
a physical medium for saving the forms.

16. The apparatus for providing forms to a user of claim 12 wherein the physical medium for saving the forms is a printer for printing the forms.

17. The apparatus for providing forms to a user of claim 12 wherein the physical medium for saving the forms is a portable digital device.

18. The apparatus for providing forms to a user of claim 12 wherein the physical medium is a hard drive.
